(19) United States
(12) Patent Application Publication
(10) Pub. No.: US 2024/0120475 A1
(43) Pub. Date: Apr. 11, 2024

(54) CATHODE ACTIVE MATERIAL FOR ALL-SOLID-STATE BATTERY WITH CONTROLLED PARTICLE SIZE AND PREPARATION METHOD THEREOF

(71) Applicants: Hyundai Motor Company, Seoul (KR); Kia Corporation, Seoul (KR)

(72) Inventors: Sung Woo NOH, Seoul (KR); Hong Seok MIN, Yongin-si (KR); Sang Heon LEE, Yongin-si (KR); Jeong Hyun SEO, Jung-gu (KR); Im Sul SEO, Jincheon-gun (KR); Chung Bum LIM, Suwon-si (KR); Ju Yeong SEONG, Seongnam-si (KR); Je Sik PARK, Seoul (KR)

(21) Appl. No.: 18/312,368

(22) Filed: May 4, 2023

(30) Foreign Application Priority Data
Oct. 5, 2022 (KR) 1020220126773

(51) Int. Cl. H01M 4/505; C01G 53/00; H01M 4/131; H01M 4/525; H01M 10/0562

(52) U.S. Cl. CPC H01M 4/505; C01G 53/50; H01M 4/131; H01M 4/525; H01M 10/0562; H01M 2004/028

(57) ABSTRACT

The present disclosure relates to a cathode active material for an all-solid-state battery with a controlled particle size and a method for preparing the same. In particular, the cathode active material includes lithium and a transition metal, wherein the cathode active material has a single peak in the range of 1 μm to 10 μm as a result of particle size distribution (PSD) analysis.

### CROSS-REFERENCE TO RELATED APPLICATION

This application claims under 35 U.S.C. § 119(a) the benefit of priority to Korean Patent Application No. 10-2022-0126773 filed on Oct. 5, 2022, the entire contents of which are incorporated herein by reference.

### TECHNICAL FIELD

The present disclosure relates to a cathode active material for an all-solid-state battery with a controlled particle size and a method for preparing the same.

### BACKGROUND

Secondary batteries capable of performing charging and discharging are used not only in small electronic devices such as mobile phones and laptops, but also in large transportation means such as hybrid vehicles and electric vehicles. Accordingly, there is a need to develop secondary batteries with higher stabilities and energy densities.

Since many of the conventional secondary batteries consist of cells based on organic liquid electrolytes, they can have limitations in improving the stabilities and energy densities.

On the other hand, all-solid-state batteries using inorganic solid electrolytes have recently been greatly spotlighted since they are based on a technology excluding organic solvents so that cells can be manufactured in a safer and simpler form.

### SUMMARY OF THE DISCLOSURE

An object of the present disclosure is to provide an all-solid-state battery with improved output.

The objects of the present disclosure are not limited to the object mentioned above. The objects of the present disclosure will become more apparent from the following description, and will be realized by means and combinations thereof described in the claims.

A cathode active material for an all-solid-state battery according to one implementation of the present disclosure may include lithium and a transition metal, and may have a single peak in the range of 1 μm to 10 μm as a result of particle size distribution (PSD) analysis.

The cathode active material may be one represented by Chemical Formula 1.

Li₁₊ₐM1ₓM2_{y}M3_{z}M4_{b}O_{c} [Chemical Formula 1]
wherein M1, M2, and M3 may each represent at least one of Ni, Co, Mn, Na, Mg, Ca, Ti, V, Cr, Cu, Zn, Ge, Sr, Ag, Ba, Zr, Nb, Mo, Al, Ga, B or any combination thereof, M4 may represent at least one of Ti, Zr, Nb, W, P, Al, Mg, V, Ca, Sr, Cr or any combination thereof, and −0.02≤a≤0.20, x+y+z+b=1, 0≤x≤1, 0≤y≤0.5, 0≤z≤0.5, 0≤b≤0.1, and 2≤c≤2.02.

The single peak may have a full width at half maximum (FWHM) of 1 to 3.5.

An area of the single peak in the result of particle size distribution (PSD) analysis may be 45 to 60.

A ratio (Area/FWHM) of an area (Area) of the single peak in the result of particle size distribution (PSD) analysis to a full width at half maximum (FWHM) of the single peak may be 23 to 40.

A method for producing a cathode active material for an all-solid-state battery according to one implementation of the present disclosure may include steps of: preparing a starting material including a lithium precursor and a transition metal precursor; sieving the starting material to obtain an intermediate material; and heat-treating the intermediate material.

In the step of sieving the starting material, the starting material may be sieved with a mesh of 0.1 μm to 30 μm to obtain an intermediate material.

In the step of sieving the starting material, the starting material may be sieved for 10 hours to 50 hours to obtain an intermediate material.

According to the present disclosure, it is possible to obtain an all-solid-state battery with improved output.

The effects of the present disclosure are not limited to the above-mentioned effect. It should be understood that the effects of the present disclosure include all effects that can be inferred from the following description.

### BRIEF DESCRIPTION OF THE DRAWINGS

FIG. 1 shows an example all-solid-state battery according to the present disclosure.

FIG. 2 shows a sample result of particle size distribution analysis of cathode active materials according to Example 1 and Comparative Example 3.

FIG. 3 shows a sample result of evaluating charging and discharging of half-cells according to Examples 1 to 3 and Comparative Examples 1 to 3.

FIG. 4 shows an example 2C discharge capacity according to the full width at half maximum.

FIG. 5A shows an example area of peaks in a sample result of particle size distribution analysis of the cathode active material according to Example 1.

FIG. 5B shows an example area of peaks in a sample result of particle size distribution analysis of the cathode active material according to Comparative Example 3.

### DETAILED DESCRIPTION

The above objects, other objects, features and advantages of the present disclosure will be easily understood through the following preferred implementations related to the accompanying drawings. However, the present disclosure is not limited to the implementations described herein and may be embodied in other forms. Rather, the implementations introduced herein are provided so that the disclosed content may become thorough and complete, and the spirit of the present disclosure may be sufficiently conveyed to those skilled in the art.

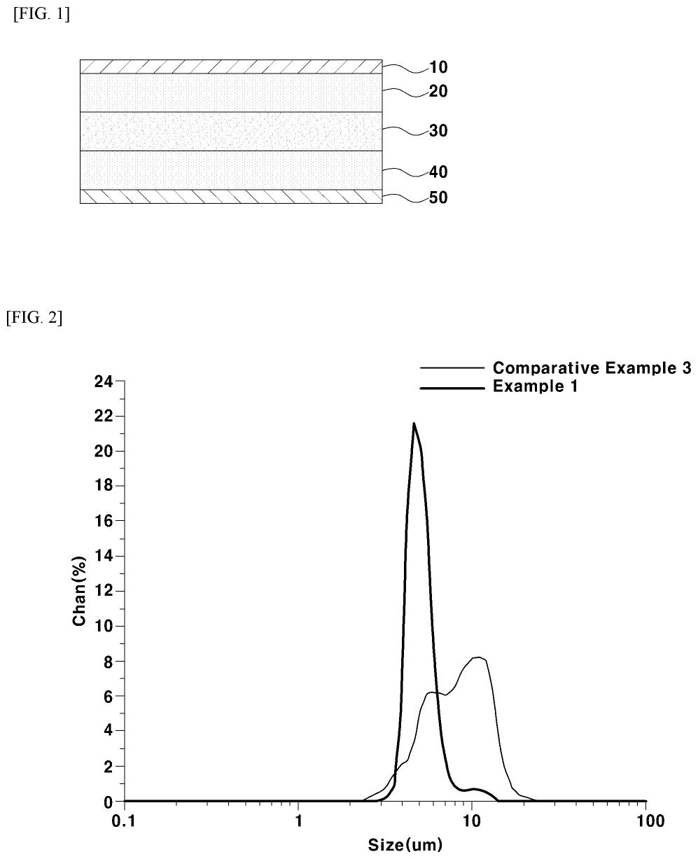

FIG. 1 shows an all-solid-state battery according to the present disclosure. The all-solid-state battery may be one in which a cathode current collector 10, a cathode layer 20, a solid electrolyte layer 30, an anode layer 40, and an anode current collector 50 are stacked.

The cathode current collector 10 may include an electrically conductive plate-shaped substrate. The cathode current collector 10 may include an aluminum foil.

The thickness of the cathode current collector 10 is not particularly limited, and may be, for example, 1 μm to 500 μm.

The cathode layer 20 may include a cathode active material.

The cathode active material may include an oxide-based cathode active material containing lithium and a transition metal. The cathode active material may include an oxide-based cathode active material represented by Chemical Formula 1 below.

Li₁₊ₐM1ₓM2_{y}M3_{z}M4_{b}O_{c} [Chemical Formula 1]

M1, M2, and M3 may each represent at least one of Ni, Co, Mn, Na, Mg, Ca, Ti, V, Cr, Cu, Zn, Ge, Sr, Ag, Ba, Zr, Nb, Mo, Al, Ga, B or any combination thereof.

M4 may represent at least one of Ti, Zr, Nb, W, P, Al, Mg, V, Ca, Sr, Cr or any combination thereof.

In Chemical Formula 1, a, x, y, z, b and c may satisfy −0.02≤a≤0.20, x+y+z+b=1, 0≤x≤1, 0≤y≤0.5, 0≤z≤0.5, 0≤b≤0.1, and 2≤c≤2.02.

The present disclosure is characterized in that the resistance in the all-solid-state battery is reduced by uniformly controlling the particle size of the cathode active material. Accordingly, an all-solid-state battery with improved output may be obtained.

In the present specification, the particle size may be measured with a laser diffraction-type particle size distribution measuring instrument. The particle size refers to the size of particles, and may refer to, for example, the particle diameter.

In general, when the cathode active material has a bimodal or trimodal particle size distribution, it can be preferable in terms of performance improvement. This is because, in the cathode active material having a bimodal or trimodal particle size distribution, the filling density of the cathode layer 20 can be increased since small particles are located in the space between the large particles. The present disclosure presents a technical idea contrary to the common sense of the above conventional art. According to the present disclosure, adjusting the particle size of the cathode active material so that it has a single peak as a result of particle size distribution (PSD) analysis can have the benefit that, if the particle size distribution of the cathode active material is made more uniform, the output of the all-solid-state battery can be increased.

The cathode active material may have a single peak in the range of 1 μm to 10 μm as a result of particle size distribution (PSD) analysis. The result of particle size distribution (PSD) analysis may be obtained through a particle size analyzer or the like. As the result of particle size distribution (PSD) analysis, the x-axis may be a particle size [μm], and the y-axis may be a relative particle amount [%].

The narrow width of the peak showed in the result of particle size distribution (PSD) analysis may mean that the particle size distribution of a sample is uniform. This can be determined by measuring a full width at half maximum (FWHM) of the peak. The cathode active material may be one in which the single peak has the full width at half maximum (FWHM) of 1 to 3.5, or 1.23 to 2.59.

The particle size distribution of the cathode active material may be controlled by sieving a starting material during the preparation process thereof. This will be described later.

An area (Area) of the single peak in the result of particle size distribution (PSD) analysis may be 45 to 60, and a ratio (Area/FWHM) of the area (Area) of the single peak to the full width at half maximum (FWHM) of the single peak may be 23 to 40.

When the particle size distribution of the cathode active material satisfies the above conditions, process efficiency, capacity and output of the all-solid-state battery, and the like may be improved in a balanced way.

The cathode active material may further include a coating layer covering the surface of the cathode active material. The coating layer may prevent a physical contact between the cathode active material and the solid electrolyte to prevent a side reaction between both constituents.

The material of the coating layer is not particularly limited, and may include LiNbO₃, Li₂CO₃, Li₃BO₃, and the like.

The thickness of the coating layer is not particularly limited, and may be 5 nm to 500 nm, or 10 nm to 100 nm.

A method for producing the cathode active material may include steps of preparing a starting material including a lithium precursor and a transition metal precursor, sieving the starting material to obtain an intermediate material, and heat-treating the intermediate material.

The lithium precursor is not particularly limited, and may include lithium hydroxide (LiOH) and the like.

The transition metal precursor may be obtained by the following method. An aqueous solution is prepared by dissolving a salt of a transition metal suitable for the composition of the desired cathode active material in water. A sodium hydroxide solution is added while stirring the aqueous solution. When resulting product is stirred, a transition metal precursor in the form of a hydroxide is precipitated.

A starting material may be prepared by weighing and mixing the lithium precursor and the transition metal precursor according to the composition of the desired cathode active material.

The starting material may be sieved with a mesh of 0.1 μm to 30 μm for 10 hours to 50 hours to obtain the intermediate material. When sieving is performed under the above conditions, a cathode active material having the aforementioned particle size distribution may be obtained.

A cathode active material may be obtained by heat-treating the intermediate material at 500° C. to 1,500° C. for 1 hour to 30 hours.

The cathode layer 20 may further include a solid electrolyte, a binder, a conductive material, and the like.

The solid electrolyte may include an oxide-based solid electrolyte, a sulfide-based solid electrolyte, and the like. It may be preferable to use a sulfide-based solid electrolyte with high lithium ion conductivity.

The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (provided that m and n are positive numbers, and Z is one of Ge, Zn, and Ga), Li₂S—GeS₂, Li₂S—SiS₂—Li₃PO₄, Li₂S—SiS₂-LiₓMO_{y} (provided that x and y are positive numbers, and M is one of P, Si, Ge, B, Al, Ga, and In), Li₁₀GeP₂S₁₂, and the like.

The oxide-based solid electrolyte may include perovskite-type Li₃ₓLa_{2/3-x}TiO₃ (LLTO), phosphate-based NASICON-type Li₁₊ₓAlₓTi₂₋ₓ(PO₄)₃ (LATP), and the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The conductive material may include carbon black, conductive graphite, ethylene black, graphene, and the like.

The cathode layer 20 may include the cathode active material and the solid electrolyte at a mass ratio of 6:4 to 9:1. If the mass ratio of the cathode active material is low, the capacity of the all-solid-state battery may be lowered, and if the mass ratio of the cathode active material is high, the content of the solid electrolyte is low so that the lithium ion conductivity in the cathode layer 20 may be lowered.

The solid electrolyte layer 30 may be interposed between the cathode layer 20 and the anode layer 40 and may include a solid electrolyte with lithium ion conductivity.

The solid electrolyte may include an oxide-based solid electrolyte, a sulfide-based solid electrolyte, and the like. It may be preferable to use a sulfide-based solid electrolyte with high lithium ion conductivity.

The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂-LiₓMO_{y} (provided that x and y are positive numbers, and M is one of P, Si, Ge, B, Al, Ga, and In), Li₁₀GeP₂S₁₂, and the like.

The oxide-based solid electrolyte may include perovskite-type Li₃ₓLa_{2/3-x}TiO₃ (LLTO), phosphate-based NASICON-type Li₁₊ₓAlₓTi₂₋ₓ(PO₄)₃ (LATP), and the like.

The anode layer 40 may include an anode active material, a binder, and the like.

The anode active material may include a carbon-based anode active material, a non-carbon based anode active material, and the like.

The carbon-based anode active material may include graphite such as mesocarbon microbeads (MCMB), highly oriented pyrolytic graphite (HOPG), or the like, and amorphous carbon such as hard carbon, soft carbon, or the like.

The non-carbon based anode active material may include a metal including at least one selected from the group consisting of In, Al, Si, Sn, and combinations thereof, a metal oxide, and the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The anode current collector 50 may be an electrically conductive plate-shaped substrate. Specifically, the anode current collector 50 may be one in the form of a sheet, a thin film, or a foil.

The anode current collector 50 may include a material that does not react with lithium. Specifically, the anode current collector 50 may include at least one selected from the group consisting of Ni, Cu, stainless steel (SUS), and combinations thereof.

The thickness of the anode current collector 50 is not particularly limited, and may be, for example, 1 μm to 500 μm.

Hereinafter, another implementation of the present disclosure will be described in more detail through Examples. The following Examples are merely examples to help the understanding of the present disclosure, and the scope of the present disclosure is not limited thereto.

### Example 1

A cathode active material represented by LiNi_{0.8}Co_{0.1}Mn_{0.1}O₂ was prepared as follows. An aqueous solution was obtained by weighing a nickel salt, a cobalt salt, and a manganese salt according to the above composition and dissolving them in distilled water. An ammonia solution and a sodium hydroxide solution were added into the aqueous solution and stirred for about 10 hours to precipitate nickel-cobalt-manganese hydroxide.

The transition metal precursor obtained as above was mixed with lithium hydroxide (LiOH) and sieved for about 20 hours to obtain an intermediate material.

The intermediate material was heat-treated at about 900° C. for about 20 hours to obtain the cathode active material.

A half-cell was manufactured using the cathode active material as follows.

A solid electrolyte layer was prepared by pressurizing a sulfide-based solid electrolyte at a pressure of about 10 MPa for about 10 seconds.

A mixture including the cathode active material, the sulfide-based solid electrolyte, and the conductive material at a mass ratio of 69:29:2 was prepared.

The mixture was applied to one surface of the solid electrolyte layer in a loading amount of about 13 mg/cm². A lithium-indium thin film was attached to the other surface of the solid electrolyte layer. The laminate obtained as above was pressurized at a pressure of about 32 MPa for about 5 minutes to obtain a half-cell.

### Example 2, Example 3, and Comparative Examples 1 to 3

Cathode active materials and half-cells comprising the same were manufactured in the same manner as in Example 1 except that the cathode active materials were prepared under the conditions shown in Table 1 below.

### Experimental Example 1—Particle Size Distribution (PSD) Analysis

The particle size distributions of the cathode active materials of Examples 1 to 3 and Comparative Examples 1 to 3 were measured with a particle size analyzer.

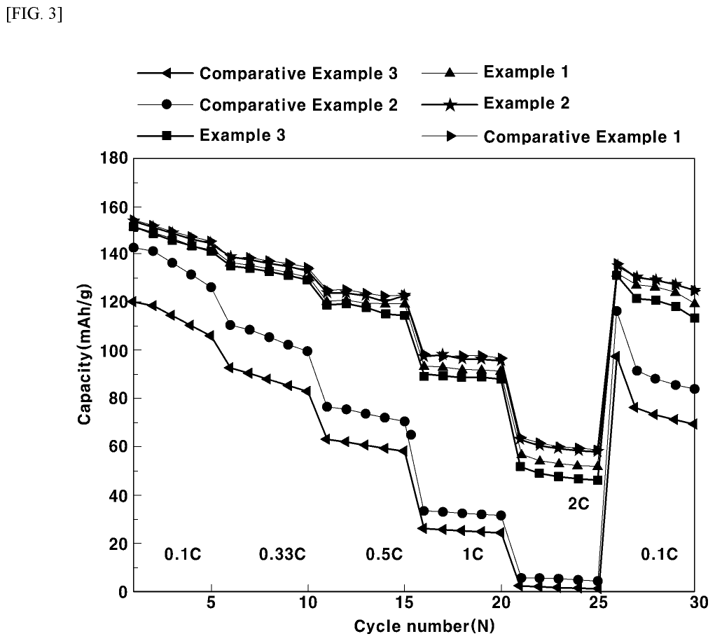

FIG. 2 shows a result of particle size distribution analysis of cathode active materials according to Example 1 and Comparative Example 3. The cathode active material of Comparative Example 3 was one prepared without performing sieving, and can be said to be a conventional cathode active material which has not been subjected to particle size control. Comparative Example 3 shows a bimodal particle size distribution, whereas Example 1 shows a single peak in the range of 1 μm to 10 μm.

The process time and full width at half maximum of each cathode active material are shown in Table 1 below.

TABLE 1

| | Process time [h] | | | | Full width |
|---|---|---|---|---|---|
| Classi- | Co- | | Heat | | at half |
| fication | precipitation | Sieving | treatment | Total | maximum |
| Comparative | 10 | 300 | 20 | 330 | 0.60 |
| Example 1 | | | | | |
| Example 2 | 10 | 50 | 20 | 80 | 1.23 |
| Example 1 | 10 | 20 | 20 | 50 | 1.78 |
| Example 3 | 10 | 10 | 20 | 40 | 2.59 |
| Comparative | 10 | 4 | 20 | 34 | 4.26 |
| Example 2 | | | | | |
| Comparative | 10 | 0 | 20 | 30 | 9.20 |
| Example 3 | | | | | |

Referring to Table 1 above, it takes too much time to obtain a cathode active material having a full width at half maximum of less than 1. Therefore, it may be preferable to adjust the particle size distribution of the cathode active material so that the single peak has a full width at half maximum of 1 or more.

### Experimental Example 2—Charge/Discharge Evaluation

The half-cells according to Examples 1 to 3 and Comparative Examples 1 to 3 were charged to −3.68 V in a constant current (CC) mode at 30° C. and 0.188 C, and then discharged to 1.88 V through the CC mode at 0.1 C. Thereafter, the voltage was kept the same and charging and discharging were performed at 0.33 C, 0.5 C, 1 C, and 2 C.

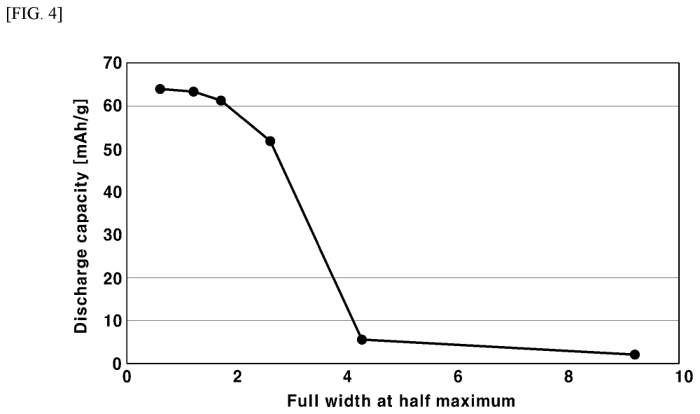

FIG. 3 shows a result of evaluating charging and discharging of half-cells according to Examples 1 to 3 and Comparative Examples 1 to 3. As results of the particle size distribution analysis, the half-cells of Comparative Examples 2 and 3 having full width at half maximum exceeding 3.5 have less capacities than those of other half-cells under all conditions.

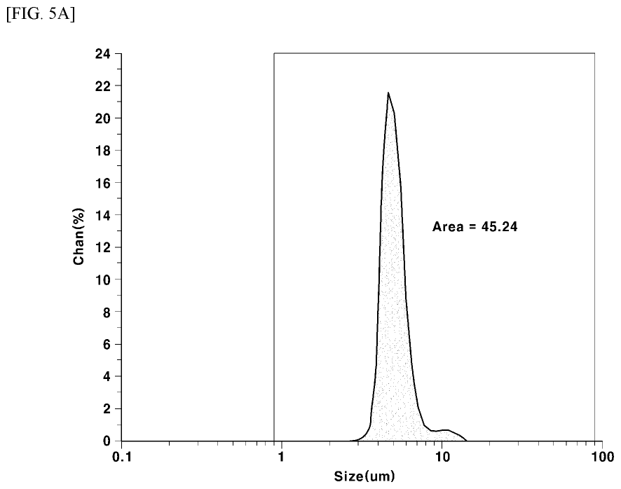

FIG. 4 shows 2C discharge capacity according to the full width at half maximum. As the full width at half maximum exceeds 3.5, the discharge capacity rapidly decreases. In addition, the difference in discharge capacity is not large between half-cells having a full width at half maximum of less than 2.

Table 2 shows the full width at half maximum values, process times, 2C discharge capacities, and process efficiencies of the cathode active materials according to Examples 1 to 3 and Comparative Examples 1 to 3. The process efficiency may mean a value obtained by dividing the 2 C discharge capacity by the process time.

TABLE 2

| | Full width | | 2 C discharge | |
|---|---|---|---|---|
| | at half | Process | capacity | Process |
| Classification | maximum | time [h] | [mAh/g] | efficiency |
| Comparative | 0.60 | 330 | 63.87 | 0.19 |
| Example 1 | | | | |
| Example 2 | 1.23 | 80 | 63.37 | 0.79 |
| Example 1 | 1.78 | 50 | 61.21 | 1.22 |
| Example 3 | 2.59 | 40 | 51.90 | 1.29 |
| Comparative | 4.26 | 34 | 5.57 | 0.16 |
| Example 2 | | | | |
| Comparative | 9.20 | 30 | 1.99 | 0.07 |
| Example 3 | | | | |

According to Table 2, the process efficiencies of Examples 1 to 3 are far more excellent than those of Comparative Examples 1 to 3.

### Experimental Example 3—Relation between Peak Area and Discharge Capacity

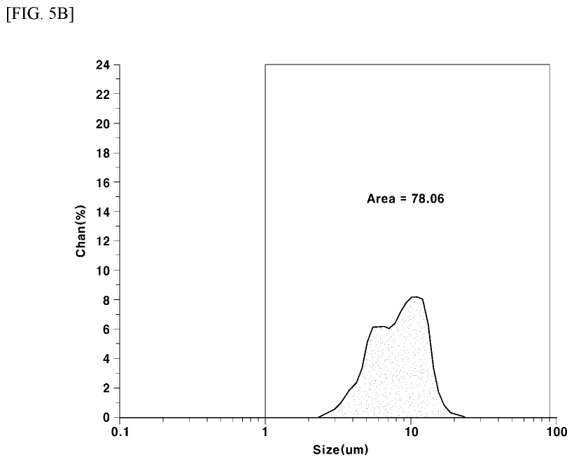

FIG. 5A shows an area of a peak in the result of a particle size distribution analysis of the cathode active material according to Example 1. FIG. 5B shows an area of peaks in the result of a particle size distribution analysis of the cathode active material according to Comparative Example 3.

Table 3 shows the areas of peaks in the result of particle size distribution analysis of the respective cathode active materials according to Examples 1 to 3 and Comparative Examples 1 to 3.

TABLE 3

| | Full width | | Peak area/Full | 2 C discharge |
|---|---|---|---|---|
| | at half | | width at half | capacity |
| Classification | maximum | Peak area | maximum | [mAh/g] |
| Comparative | 0.60 | 49.26 | 82.1 | 63.87 |
| Example 1 | | | | |
| Example 2 | 1.23 | 47.29 | 38.4 | 63.37 |
| Example 1 | 1.78 | 45.24 | 25.4 | 61.21 |
| Example 3 | 2.59 | 59.65 | 23.0 | 51.90 |
| Comparative | 4.26 | 85.61 | 20.0 | 5.57 |
| Example 2 | | | | |
| Comparative | 9.20 | 75.06 | 8.16 | 1.99 |
| Example 3 | | | | |

According to Table 3, Examples 1 to 3 in which the peak areas are 45 to 60, and the ratios (peak areas/full width at half maximum values) of the peak areas to the full width at half maximum values are 23 to 40 show superiorly higher 2C discharge capacities than those of Comparative Examples 2 and 3.

Although various examples of the present disclosure have been described in detail above, the right scope of the present disclosure is not limited to the above-described examples, and various modifications and improved forms by those skilled in the art using the basic concept of the present disclosure as defined in the following claims are also included in the right scope of the present disclosure.

What is claimed is:

1. A cathode active material for an all-solid-state battery comprising:
lithium; and
a transition metal,
wherein the cathode active material has a single peak in the range of 1 μm to 10 μm based on particle size distribution (PSD) analysis.

2. The cathode active material of claim 1, wherein the cathode active material is represented by Li₁₊ₐM1ₓM2_{y}M3_{z}M4_{b}O_{c},
wherein M1, M2, and M3 each represents at least one of Ni, Co, Mn, Na, Mg, Ca, Ti, V, Cr, Cu, Zn, Ge, Sr, Ag, Ba, Zr, Nb, Mo, Al, Ga, B, or combinations thereof,
M4 represents at least one of Ti, Zr, Nb, W, P, Al, Mg, V, Ca, Sr, Cr, or combination thereof, and
−0.02≤a≤0.20, x+y+z+b=1, 0≤x≤1, 0≤y≤0.5, 0≤z≤0.5, 0≤b≤0.1, and 2≤c≤2.02.

3. The cathode active material of claim 1, wherein the single peak has a full width at half maximum (FWHM) of 1 to 3.5.

4. The cathode active material of claim 1, wherein an area of the single peak based on PSD analysis is 45 to 60.

5. The cathode active material of claim 1, wherein a ratio of an area of the single peak based on PSD analysis to a full width at half maximum (FWHM) of the single peak is 23 to 40.

6. A cathode for an all-solid-state battery, comprising;
the cathode active material of claim 1; and
a sulfide-based solid electrolyte.

7. A method for producing a cathode active material for an all-solid-state battery comprising:
preparing a starting material comprising a lithium precursor and a transition metal precursor;
sieving the starting material to obtain an intermediate material; and
heat-treating the intermediate material,
wherein the cathode active material has a single peak in the range of 1 μm to 10 μm based on particle size distribution (PSD) analysis.

8. The method of claim 7, wherein the starting material is sieved with a mesh of 0.1 μm to 30 μm to obtain the intermediate material.

9. The method of claim 7, wherein the starting material is sieved for 10 hours to 50 hours to obtain the intermediate material.

10. The method of claim 7, wherein the cathode active material is represented by Li₁₊ₐM1ₓM2_{y}M3_{z}M4_{b}O_{c},
wherein M1, M2, and M3 each represents at least one of Ni, Co, Mn, Na, Mg, Ca, Ti, V, Cr, Cu, Zn, Ge, Sr, Ag, Ba, Zr, Nb, Mo, Al, Ga, B, or combination thereof,
M4 represents at least one of Ti, Zr, Nb, W, P, Al, Mg, V, Ca, Sr, Cr, or combination thereof, and
−0.02≤a≤0.20, x+y+z+b=1, 0≤x≤1, 0≤y≤0.5, 0≤z≤0.5, 0≤b≤0.1, and 2≤c≤2.02.

11. The method of claim 7, wherein the single peak has a full width at half maximum (FWHM) of 1 to 3.5.

12. The method of claim 7, wherein an area of the single peak based on PSD analysis is 45 to 60.

13. The method of claim 7, wherein a ratio of an area of the single peak based on PSD analysis to a full width at half maximum (FWHM) of the single peak is 23 to 40.
